(19) United States
(12) Patent Application Publication
(10) Pub. No.: US 2022/0267125 A1
(43) Pub. Date: Aug. 25, 2022

(54) SNATCH RING FOR OFF-ROAD VEHICLE RECOVERY

(71) Applicant: Specialist Wholesalers Pty Ltd, Mount Waverley (AU)

(72) Inventor: Troy Schipper, Mount Waverley (AU)

(21) Appl. No.: 17/651,558

(22) Filed: Feb. 17, 2022

(30) Foreign Application Priority Data
Feb. 19, 2021 (AU) 2021900429

(51) Int. Cl. B66D 3/26

(52) U.S. Cl. CPC B66D 3/26; B66D 2700/026; B66D 2700/021

(57) ABSTRACT

A snatch ring for off-road vehicle recovery has an annular core and an outer sheave. The outer sheave has an outer winch line groove and the annular core and the outer sheave are concentric. The annular core is rotatably engaged to the outer sheave so that the annular core and the outer sheave can rotate with respect to each other about an axis of rotation. The annular core has an anchor loop passage therethrough.

### FIELD OF THE INVENTION

This invention relates generally to a snatch ring for off-road vehicle recovery.

### BACKGROUND OF THE INVENTION

Pulleys are used in 4×4 recoveries to derive mechanical advantage. A commonly used pulley arrangement is a snatch block which comprises an inner sheave rotatably engaged about a pin within an outer shell having an outer strap. A winch line goes around a groove of the sheave through a swallow defined by the shell of the snatch block whilst the outer strap is anchored by an anchor loop, typically wire, to an anchor.

The advent of ultra-high molecular weight polyethylene (UHMwPE) soft shackles nowadays allows for the use of snatch rings which are a simpler and cheaper alternative to snatch blocks whilst providing similar load ratings.

A snatch ring is essentially an annulus having an outer groove around which the winch line is doubled back, and which defines a passage therethrough through which a soft shackle anchor loop is engaged. The passage has smooth edges and the low friction properties of the soft shackle anchor loop allow the snatch ring to rotate with respect to the soft shackle anchor.

However, these snatch rings cannot be used with steel bow shackles which are much cheaper and more commonly found in recovery kits as compared to soft shackles.

The present invention seeks to provide a snatch ring which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a snatch ring for off-road vehicle recovery comprising an annular core and an outer sheave. The outer sheave comprises an outer winch line groove. Furthermore, the annular core and the outer sheave are concentric and the annular core is rotatably engaged to the outer sheave so that the annular core and the outer sheave can rotate with respect to each other about an axis of rotation. The annular core comprises an anchor loop passage therethrough.

As such, in use, for off-road vehicle recovery, and anchor loop may be secured through the passage and a winch line doubled back around the outer winch line groove of the sheave. When the winch line is drawn in, the outer sheave rotates as the winch line goes around the sheave whilst the inner core remains static with respect to the anchor loop.

As such, the present snatch ring allows for use of both soft and metallic anchor loops.

The annular core may define an outer cylindrical bearing surface, the sheave may define a corresponding inner cylindrical bearing surface and a sleeve bushing may interface between the inner and outer bearing surfaces which therefore increases the load rating capacity of the present snatch ring. Furthermore, use of sleeve bushing degreases rotational friction as compared to traditional snatch rings thereby allowing for more efficient winching.

Furthermore, the reduction in rotational friction reduces wear of the surface of the winch line groove (which may have an anodised coating). Reducing wear of the anodised coating furthermore reduces wear on the winch rope itself.

Furthermore, the reduction of rotational frequency reduces or eliminates heat generation which may degrade synthetic rope.

Furthermore, the present snatch ring may be disassembled wherein the annular core is removable from the sheave along the axis of rotation. The annular core may comprise a circular groove which removably engages a circlip against a corresponding face of the sheave at one side of the snatch ring and the annular core may comprise a flange which bears against a corresponding face of the sheave at an opposite side of the snatch ring.

The sheave may comprise recesses for the flange and circlip such that the circlip does not protrude beyond the corresponding face of the sheave at one side of the snatch ring and the flange does not protrude beyond the corresponding face of the sheave at the opposite side of the snatch ring.

At each side of the snatch ring, the sheave may define an outer planar face and the annular core may define an inner planar face which is substantially coplanar with the outer planar face which therefore does not interfere with the anchor loop when rotating with respect to the inner core.

In embodiments, the passage through the annular core may be noncircular in cross-section perpendicular with respect to the axis of rotation. In this regard, the cross-section may comprise more than two radial extremities. For example, in an embodiment, the cross-section may comprise three radial extremities such that the passage is substantially triangular-shaped in cross-section. As such, anchor loop locates within one of the radial extremities to resist the annular core rotating with respect to the anchor loop.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 illustrates a method of off-road vehicle recovery using a snatch ring to derive a 2-to-1 mechanical advantage;

FIG. 2 illustrated use of a snatch ring in accordance with an embodiment;

FIG. 3 shows a first side face exploded perspective representation of a snatch ring in accordance with an embodiment;

FIG. 4 shows an opposite side face assembled perspective representation of the snatch ring of FIG. 3;

FIG. 5 shows a first side face assembled view of the snatch ring of FIG. 3;

FIG. 6 shows a side-on assembled view of the snatch ring of FIG. 3; and

FIG. 7 shows an opposite side face assembled view of the snatch ring of FIG. 3.

### DESCRIPTION OF EMBODIMENTS

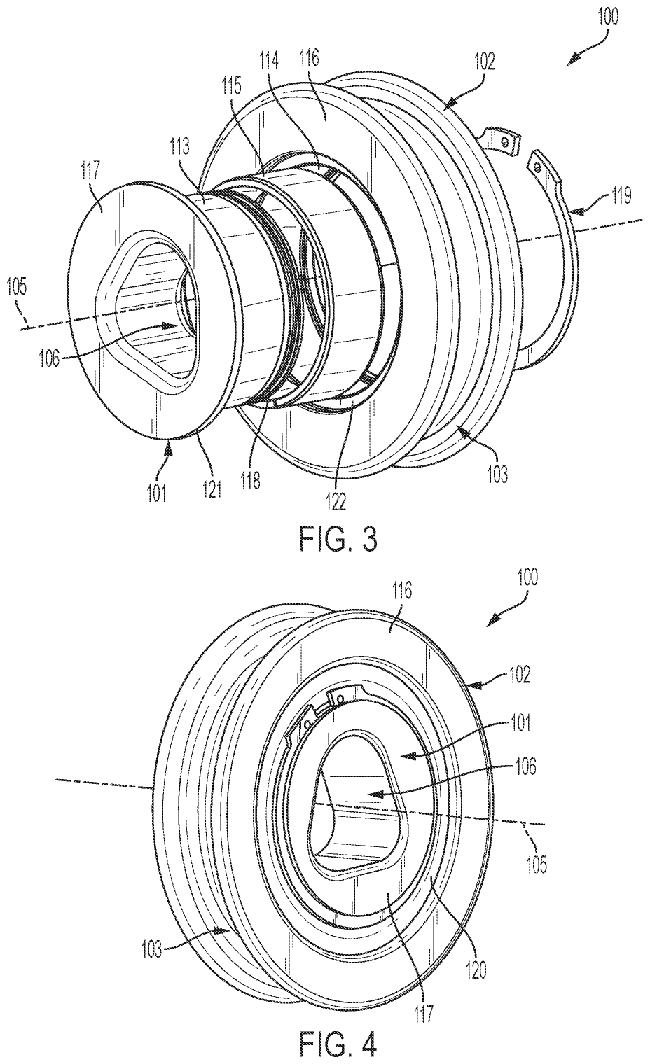

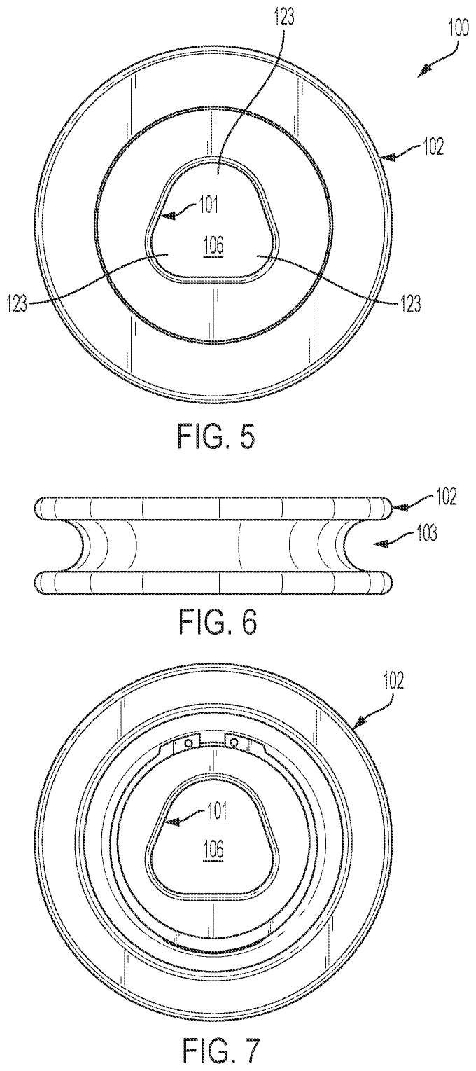

FIG. 3 shows an exploded representation of a snatch ring 100 for off-road vehicle recovery. The snatch ring 100 comprises an annular core 101 and an outer sheave 102. The outer sheave 102 comprises an outer winch line groove 103 for a winch line 104. As is shown in FIGS. 5 and 7, the annular core 101 and the outer sheave 102 are concentric.

The annular core 101 is rotatably engaged to the outer sheave 102 so that the annular core 101 and the outer sheave 102 can rotate with respect to each other about an axis of rotation 105.

The annular core 101 defines an anchor loop passage 106 therethrough.

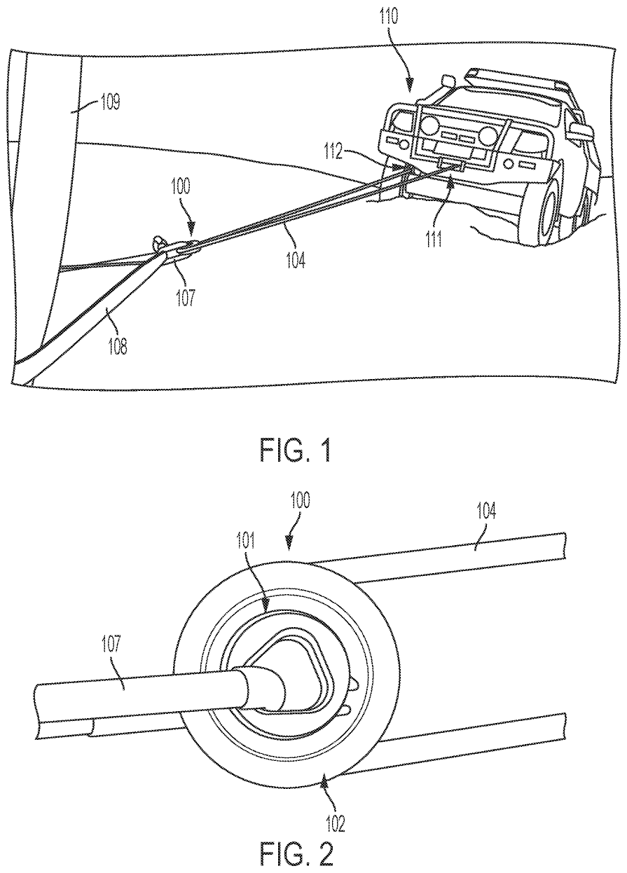

As is illustrated in FIGS. 1 and 2, a winch line 104 from a vehicle 110 may be doubled back from a winch 111 via the snatch ring 100 and attached to a recovery point 112 to derive a 2-to-1 mechanical advantage.

An anchor loop 107 going through the anchor loop passage 106 may be secured to an anchor 109, such as a tree, rock or the like. In the embodiment shown, the anchor loop 107 comprises a soft shackle 107 attached to an anchor strap 108. In alternative embodiments, a metallic anchor loop, such as a steel bow shackle may go through the anchor loop passage 106. As the winch 111 draws in the winch line 104, the outer sheave 102 turns with the winch line 104 going around the groove 103 thereof whilst the inner core 101 remains static with the anchor loop 107.

As is shown in FIG. 3, the annular core 101 may define an outer cylindrical bearing surface 113, the sheave 102 may define a corresponding inner cylindrical bearing surface 114 and a cylindrical sleeve bushing 115 may interface the outer cylindrical bearing surface 113 and the inner cylindrical bearing surface 114.

The sleeve bushing 115 may be polymeric, such as being one comprising Polytetrafluoroethylene (PTFE). The annular core 101 may comprises chromoly such as chromoly 4140M and the sheave 102 may comprises an alloy.

The snatch ring 100 may define planar faces. Specifically, with reference to FIGS. 3 and 4, at each side of the ring 100, the sheave 102 may define an outer planar side face 116 and the inner core 101 may define a corresponding inner planar side face 117. Furthermore, at each side, the outer planar side face 116 and the corresponding inner planar side face 117 may be substantially coplanar.

The annular core 101 may be removable from the sheave 102 along the axis of rotation 105.

As shown in FIG. 3, the annular core 101 may comprise a circlip groove 118 which removably engages a circlip 119 against a corresponding face of the sheave 102.

As is shown in FIG. 4, the corresponding face of the sheave 102 may comprise an annular recess 120 for the circlip 119 such that the circlip 119 does not protrude out from the corresponding face of the sheave 102.

Furthermore, the annular core 101 may comprise a flange 121 at an opposite side of the circlip groove 118 which bears against the corresponding face of the sheave 102. Similarly, the corresponding face of the sheave 102 may comprise a recess 122 for the flange 121 such that the outer planar side face 116 of the sheave 102 and the inner planar side face 117 of the core 101 are substantially coplanar.

As is illustrated in FIGS. 5 and 7, the passage 106 may be noncircular in cross-section perpendicular to the rotational axis 105. In this regard, the passage 106 may define more than two radial extremities 123. In the embodiment shown, the passage 106 is substantially triangular shaped in comprising three radial extremities 123. In use, the anchor loop 107 locates within one of the radial extremities 123 to resist the rotation of the inner core 101 with respect to the anchor loop 107.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A snatch ring for off-road vehicle recovery comprising an annular core and an outer sheave, the outer sheave comprising an outer winch line groove, the annular core and the outer sheave being concentric, the annular core rotatably engaged to the outer sheave so that the annular core and the outer sheave can rotate with respect to each other about an axis of rotation and the annular core comprising an anchor loop passage therethrough.

2. The snatch ring as claimed in claim 1, wherein the annular core defines an outer cylindrical bearing surface and wherein the sheave defines a corresponding inner cylindrical bearing surface and wherein the snatch ring comprises a sleeve bushing interfacing the inner and outer bearing surfaces.

3. The snatch ring as claimed in claim 2, wherein the sleeve bushing is polymeric.

4. The snatch ring as claimed in claim 3, wherein the sleeve bushing comprises PTFE.

5. The snatch ring as claimed in claim 2, wherein the sleeve bushing is solid.

6. The snatch ring as claimed in claim 1, wherein the snatch ring defines planar side faces.

7. The snatch ring as claimed in claim 6, wherein, at each side, the sheave defines an outer planar side face and wherein the annular core defines a corresponding inner planar side face wherein the outer planar side face and the corresponding inner planar side face substantially coplanar.

8. The snatch ring as claimed in claim 1, wherein the annular core is removable from the sheave along the axis of rotation.

9. The snatch ring as claimed in claim 8, wherein the annular core comprises a circlip groove which removably engages a circlip against a corresponding face of the sheave.

10. The snatch ring as claimed in claim 9, wherein the corresponding face of the sheave comprises a recess for the circlip such that the circlip does not protrude out from the face of the sheave.

11. The snatch ring as claimed in claim 8, wherein the annular core comprises a flange which bears against a corresponding face of the sheave.

12. The snatch ring as claimed in claim 11, wherein the corresponding face of the sheave comprises a recess for the flange such that a corresponding face of the core and the corresponding face of the sheave are substantially coplanar.

13. The snatch ring as claimed in claim 1, wherein the passage is noncircular in cross-section perpendicular to the axis of rotation.

14. The snatch ring as claimed in claim 13, wherein the passage comprises more than two radial extremities.

15. The snatch ring as claimed in claim 14, wherein the passage comprises three radial extremities.

16. The snatch ring as claimed in claim 1, wherein the annular core comprises chromoly.

17. The snatch ring as claimed in claim 1, wherein the sheave comprises an alloy.

18. A method for off-road vehicle recovery using a snatch ring as claimed in claim 1, the method comprising securing an anchor loop through the passage and doubling back a winch line through the outer winch line groove of the sheave such that the sheave rotates with respect to the annular core.

19. The method as claimed in claim 18, wherein the annular core remains static whilst the outer sheave rotates.

20. The method as claimed in claim 18, wherein the anchor loop is metallic.

21. The method as claimed in claim 18, wherein the passage is non-circular in cross-section perpendicular to the axis of rotation, wherein the passage comprises more than two radial extremities and wherein the anchor loop locates within one of the radial extremities to resist the rotation of the annular core.

22. The method as claimed in claim 18, wherein the annular core is removable from the sheave along the axis of rotation, wherein the annular core comprises a circlip groove which removably engages a circlip against a corresponding face of the sheave and wherein the method further comprises disassembling the snatch ring by removing the circlip and removing the annular core from the outer sheave along the axis of rotation.
